(19) United States
(12) Patent Application Publication
(10) Pub. No.: US 2010/0200331 A1
(43) Pub. Date: Aug. 12, 2010

(54) Toolshelf for extension ladder

(76) Inventor: Gregory Quinten Hager, Brooks, GA (US)

Correspondence Address: J.T. HOLLIN, ATTORNEY AT LAW, PC, 110 HABERSHAM DRIVE, SUITE 144, FAYETTEVILLE, GA, 30214, US

(21) Appl. No.: 12/322,829

(22) Filed: Feb. 7, 2009

(51) Int. Cl. E06C 7/14; E06C 1/04; E06C 1/12

(52) U.S. Cl. 182/107; 182/129

(57) ABSTRACT

A toolshelf for an extension ladder comprising an essentially rectangular, planar toolshelf sized to fit horizontally between the legs of the ladder. The toolshelf is secured to a rung of the extension ladder by means of a pair of “U” bolts extending through the top surface of the toolshelf, stridling the rung, and secured by a bracket and threaded fasteners attached to the “U” bolt legs underneath the rung. The toolshelf is constructed with a curvilinear, orthogonal, or “V”-shaped cutout excised from its front edge for the purpose of stabilizing the combined toolshelf and extension ladder when the connected toolshelf is braced against the exterior corner of a structure, a pole, or a tree, in the act of performing work while standing upon the extension ladder.

### CROSS-REFERENCES TO RELATED APPLICATIONS

### U.S. Patent Documents

| Ser. No. | U.S. Class | Date | Inventor |
|---|---|---|---|
| 4,100,998 | 182/116 | Jul. 18, 1978 | Marquez, M. |
| 4,401,187 | 182/121 | Aug. 30, 1983 | Van Patten, C. |
| 4,437,544 | 182/120 | Mar. 20, 1984 | Anderson, H., et al |
| 4,460,063 | 182/116 | Jul. 17, 1984 | Casada, E. |
| 4,706,918 | 248/210 | Nov. 17, 1987 | Wilson, R. |
| 5,044,466 | 182/221 | Sep. 03, 1991 | Jacobsmeyer, Jr., D. |
| 5,052,581 | 220/570 | Oct. 01, 1991 | Christ, J., et al |
| 5,388,665 | 182/222 | Feb. 14, 1995 | Newman, D. |
| 5,975,240 | 182/222 | Nov. 02, 1999 | O'Brien, S. |
| 6,412,601 | 182/129 | Jul. 02, 2002 | Schmidt, P. |
| 6,698,548 | 182/129 | Mar. 02, 2004 | Verrill, E |

### U.S. Patent Application Publications

| Publication No. | U.S. Class | Date | Inventor |
|---|---|---|---|
| 2007/0137929 | 182/129 | Jun. 21, 2007 | Whitaker, R. |
| 2006/0118360 | 182/18 | Jun. 08, 2006 | Rivers, P., et al |

### Other References

Little Giant Ladder Work Platform; Wing Enterprises, Springville, Utah, USA; www.littlegiantladders.com

### Sierra Tools Ladder Platform; Trademark Global

### B Ladder Platform; General Machine Products Co., 3111 Old Lincoln Hwy, Trevose, Pa. 19053 USA

### STATEMENT REGARDING FEDERALLY SPONSORED RESEARCH OR DEVELOPMENT

Not applicable.

### NAMES OF THE PARTIES TO A JOINT RESEARCH AGREEMENT

There is no joint research agreement in conjunction with this invention.

### REFERENCE TO A “SEQUENCE LISTING,” A TABLE, OR A COMPUTER PROGRAM LISTING APPENDIX

Not applicable.

### BACKGROUND OF THE INVENTION

(1) Field of the Invention

This inventive concept relates to step ladders and extension ladders, and more particularly, to an improved work shelf that may be attached to a step or rung of an extension ladder to facilitate the use of tools and equipment by a worker. This device also serves the purpose of providing stability for the upper extension of the ladder so that the ladder may be placed against an orthogonal corner of a building during the process of performing work at a height.

(2) Description of the Related Art

The prior art contains a number of work shelves, platforms, steps and attachable accessories that may be used in conjunction with an extension ladder. U.S. Pat. No. 4,100,998 (Marquez, 1978) features a platform with a rail on each side, enabling the platform to move horizontally over a round-headed bolt fastened on each inside leg of the ladder. The distal end of the platform is secured by rigid hooks to a rung of the ladder while support arms clamped to a second, lower rung provide vertical strength to the proximate end of the platform.

U.S. Pat. No. 4,401,187 (Van Patten 1983) features a ladder platform designed for one end of the platform to rest on one rung of a ladder. The opposite end of the platform has a resilient, irregularly shaped bracket on each side, each bracket capable of being maneuvered to fit around the exterior of each leg of the ladder and inserted into the apertures formed on each side of the ladder by the next higher rung.

A hinged stepladder work bench is disclosed in U.S. Pat. No. 4,460,063 (Casada 1984). A platform with an underledge has at one end a rigid bracket attached to each side of the platform. Each bracket is also pivotally attached to its respective ladder rail proximate the second highest step of the ladder. The platform can thus be swiveled into position to rest on the topmost step of the stepladder for work, or lifted off the step and rotated downward to be stored against the ladder rails.

U.S. Pat. No. 5,052,581 presents a ladder-supported holding tray that requires two rungs of a ladder for operation. The proximate end of the tray has a horizontally-oriented “U” prong on each side of the tray, both of which slide into a secure fitted position over the higher rung. The bottom of the tray is attached to a moveable bracket which has at its opposite end a third “U” prong which is placed into position encompassing the lower rung and then securely clamped into place.

### BRIEF SUMMARY OF THE INVENTION

This invention relates to the use of work platforms used in conjunction with ladders. In particular, this inventive concept presents a toolshelf for an extension ladder comprising an essentially rectangular platform designed to attach to a rung of the extension ladder by means of a pair of “U” bolts extending through the top surface of the toolshelf and secured to the rung by threaded U-bolts and any of a variety of compatible brackets and fasteners. The toolshelf is further constructed with an indented receptacle for the holding of small parts and materials. Several different-sized holes are constructed through the depth of the toolshelf for the retention of tools and equipment. A cutout on the front edge of the toolshelf facilitates the use of the toolshelf where necessary to perform work while braced against the orthogonal corner of a structure. The cutout may be any one of a variety profiles, including curvilinear, “V”-shaped, or orthogonally oriented to the front edge of the toolshelf. The cutout is also a valuable safety feature for bracing the toolshelf and extension ladder combination against a pole or tree.

The device is light in weight, can be easily attached to the extension ladder prior to starting a project, and is easily disengaged and stored, either on a rung of the same ladder being used, or placed in a different location for future use.

### BRIEF DESCRIPTION OF THE VIEWS OF THE DRAWINGS

Preliminarily, a listing of the components of the invention, as described in FIG. 1 through FIG. 5 is presented:
1. Toolshelf
2. V-cutout
3. U-bolt
4. Threaded leg
5. Wing nut
6. U-bolt bracket
7. Paired U-bolt channels
8. Toolshelf top surface
9. Toolshelf bottom surface
10. Paintbrush holder
11. Hammer receptacle
12. Extension ladder
13. Rung of ladder
14. Retainer notch
15. Strap retainer
16. Tool strap
17. Elastomeric material
18. Small parts receptacle
19. Tree cross-section
20. Tool holders
21. Attachment holes
22. Harness
23. Adjustment device
24. Fastening device
25. Toolshelf front
26. Corner of building edge

FIG. 1 is a plan view of the top surface of the toolshelf.

FIG. 2 is an elevation view of the front edge of the toolshelf, primarily depicting the V-cutout.

FIG. 3 presents a cutaway view of the toolshelf, as seen from the A-A section line depicted in FIG. 1.

FIG. 4 presents a view of a U-bolt.

FIG. 4(a) is a bracket for fitting over the threaded legs of the U-bolt.

FIG. 4(b) is a typical wing nut suitable for mating with the U-bolt.

FIG. 5 is a partial view of an extension ladder braced against the corner of a structure with a U-bolt in the process of being inserted over a rung of the ladder.

FIG. 6 depicts the toolshelf braced against a tree trunk (cutaway view of the tree).

### DETAILED DESCRIPTION OF THE INVENTION

The principal object of this inventive concept is to present a significant improvement over much of the prior art, in particular, the design of a “V-cutout” suitable for bracing an extension ladder, with the toolshelf attached, against odd shaped building surfaces, poles, or trees. The V-cutout facilitates bracing of the ladder while working in the vicinity of an exterior corner of a building or a room of a building. The toolshelf may feature any of a wide variety of cutout profiles to further enhance safety of operation when the toolshelf, being securely attached to the top rung of an extension ladder, is braced against a workpiece other than the flat side of a building or wall structure.

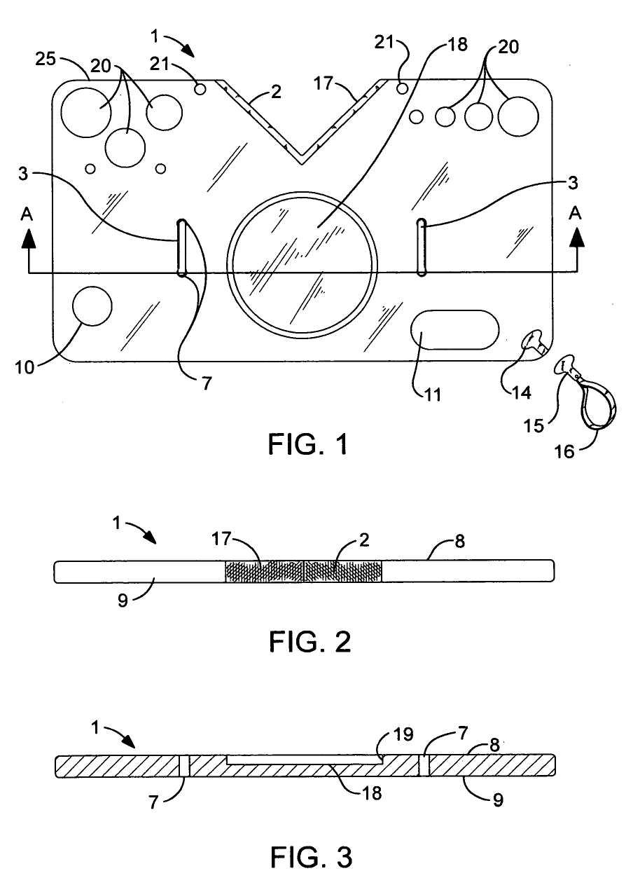

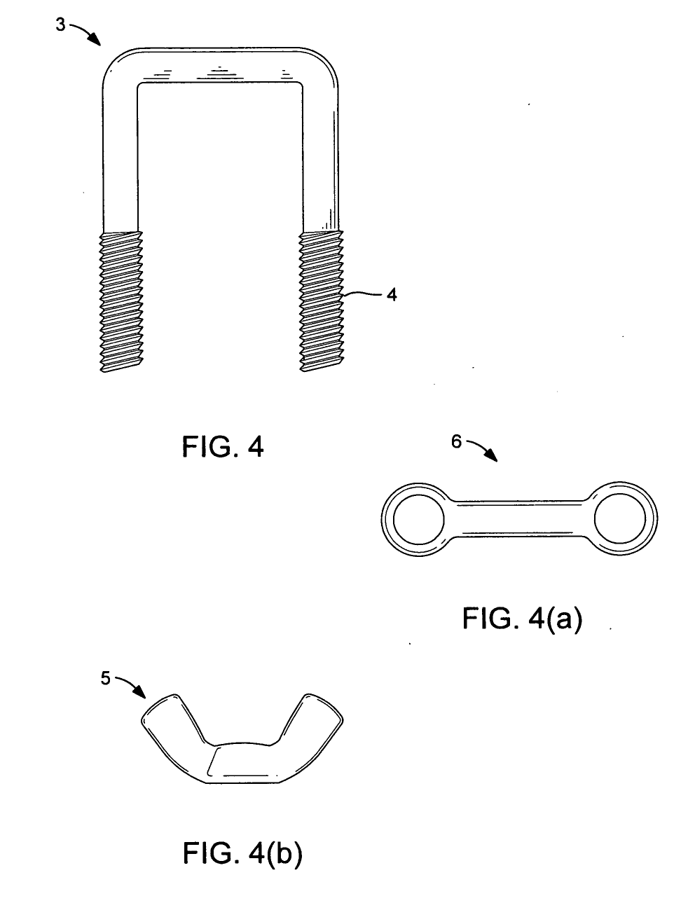

In referring to FIG. 1, which shows a plan view of the top surface of the toolshelf 1, we begin a summation of the invention's features. For illustrative purposes only, the following descriptive details will pertain to a toolshelf 1 designed with a “V” cutout. In this embodiment, the “V”-cutout 2 serves to allow a worker to place the ladder against the exterior corner of a building or an exterior corner along a hallway. The toolshelf 1 may also serve to securely brace an extension ladder against a pole or tree during outside work projects.

FIG. 1 further shows the tops of the U-bolts 3, apertures for tool holders 20, a circular small parts receptacle 18, a tool strap 16, strap retainer 15, attachment holes 21 for a tree or pole harness 22, and other features. Another feature of the toolshelf 1 is the inclusion of a magnetized circular receptacle 18 suitable for the storing of a variety of small parts and equipment.

Another feature of the toolshelf 1 is a toolstrap 16, attached to a strap retainer 15, which strap retainer 15 is insertable into a retainer notch 14 machined into a corner of the toolshelf 1. The toolstrap 16 is suitable for carrying, in a hanging manner, any medium-sized tool, including an electric drill, that may be necessary in the performance of a job.

A user of the ladder/toolshelf 1 combination must begin by placing one of two U-bolts 3 through one of the paired U-bolt channels 7 on either the left or right side of the toolshelf 1. He/she next places the second U-bolt 3 through the remaining U-bolt channel 7 on the opposite side of the toolshelf 1. At this juncture, the entire toolshelf 1, along with the U-bolts 3, are in position over the top rung 13 of the extension ladder 12. The worker must then ensure that the threaded legs 4 of each U-bolt 3 straddle the rung 13 and extend downward past the bottom surface of the rung 13. A U-bolt bracket 6 is then pushed upwardly, encompassing both threaded U-bolt legs 4, followed by the attachment of a wing nut 5 onto each U-bolt leg 4 using as many turns of the wing nut 5 as necessary to render a tight joining.

Once the toolshelf 1 is secured to the rung 13 the extension ladder 12 may be maneuvered to place it on a stable angle against the vertical wall surface, the front edge 25 of the toolshelf 1 abutting the wall to provide a steady support. The worker may then climb to the upper levels of the extension ladder 12 while carrying in hand a can of paint, tools, and other equipment that may be required for the ensuing job.

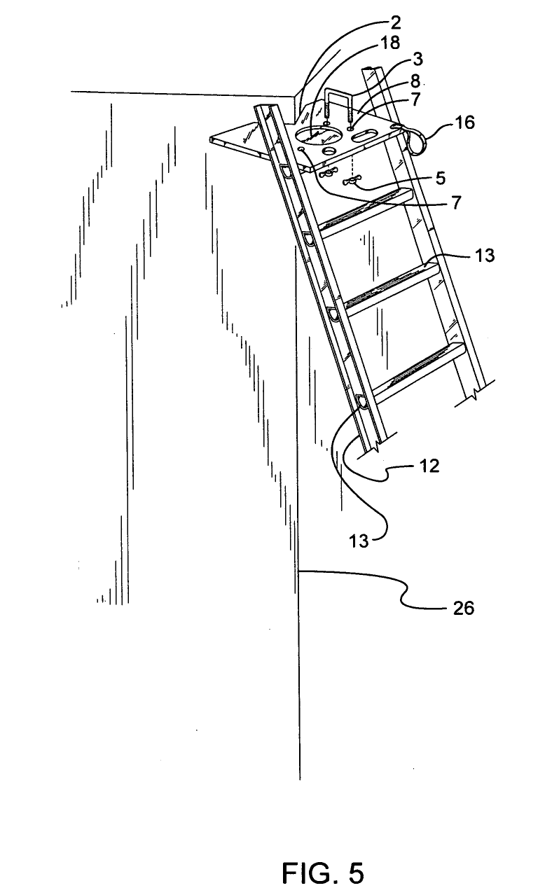

By using the described invention, an extension ladder 12 may be set against the corner of a room within a building, as depicted in FIG. 5, by first securing the toolshelf 1 to the top rung 13 of the extension ladder 12. The assembled combination of extension ladder 12 and toolshelf 1 is then placed in position so as to allow the V-cutout 2 to fit snugly onto the corner. A layer of elastomeric material 17 is adhesively attached to the V cutout 2 to provide traction against the surface of the corner and/or minimize any scrapes or damage to the wall surface.

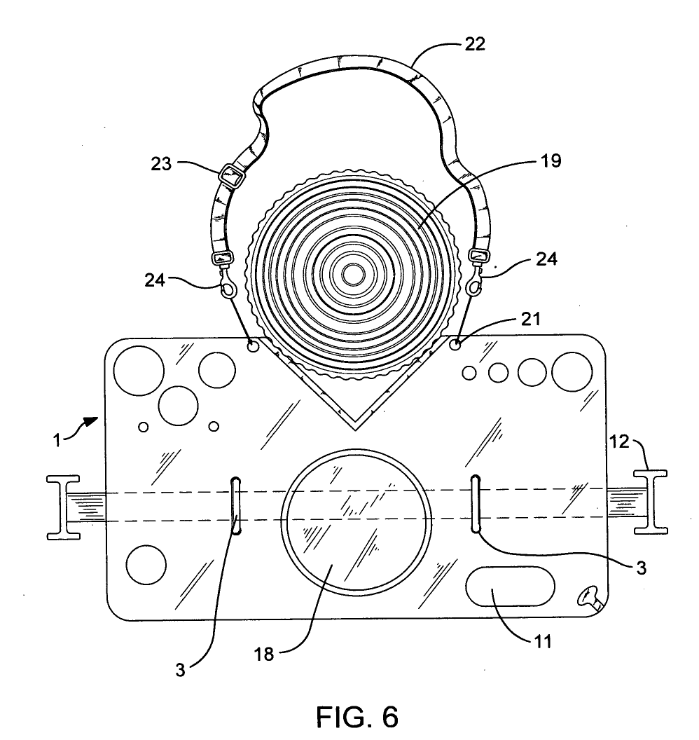

In conjunction with the toolshelf 1, an extension ladder 12 may be utilized for work involving a pole or a tree trunk, as shown in FIG. 6. The assembled combination of extension ladder 12 and toolshelf 1 is placed in position so as to allow the V-cutout 2 to snugly fit onto the pole or tree 19. For additional stability and security, a harness 22 is secured around the circumference of the pole or tree 19 by clasping one end of the harness 22, along with its integral fastening device 24, to an attachment hole 21 on the toolshelf 1. Immediately afterwards, the opposite end of the harness 22 and its fastening device 24 must be affixed to the toolshelf 1 by means of another attachment hole 21.

Having described the basic embodiments of this toolshelf for an extension ladder, it is believed that other modifications, improvements, and changes to this invention will be suggested to those skilled in the art in view of the teachings set forth herein. It is therefore to be understood that all such variations, improvements, and changes are considered to fall within the scope of the present invention.

What is claimed is:

1. An essentially planar toolshelf for an extension ladder, said toolshelf having a top surface, a bottom surface, a front edge, a back edge, and two side edges, further having a cutout excised from said front edge of said toolshelf, and having a means of attachment of said toolshelf to a step or rung of an extension ladder.

2. An essentially planar toolshelf for an extension ladder, said toolshelf having a top surface, a bottom surface, a front edge, a back edge, and two side edges, further having a “V”-shaped cutout excised from said front edge of said toolshelf, whereby the open end of said “V”-shaped cutout is excised from said front edge and having a means of attachment of said toolshelf to a step or rung of an extension ladder.

3. A toolshelf as in claim 1, further having
a magnetized, counter-sunk, circular indentation in the geometric center of said work shelf;
a plurality of circular apertures drilled through said top and bottom surfaces, such apertures capable of holding common work tools and equipment;
a layer of elastomeric material adhesively affixed to said “V”-shaped cutout; and
a means of attachment of said toolshelf to a rung of an extension ladder, said means comprising two “U” bolts, each inserted into two compatible through-holes proximate and parallel to each side of said toolshelf with the legs of said “U” bolts of sufficient length to extend past the bottom surface of the rung of said ladder, thereby allowing the affixation, to each “U”-bolt, (a) a bracket accommodative of both said legs and (b) a suitable wing nut from below said bracket onto each leg of said “U”-bolts.

4. A toolshelf as in claim 2, further having
a magnetized, counter-sunk, circular indentation in the geometric center of said work shelf;
a plurality of circular apertures drilled through said top and bottom surfaces, such apertures capable of holding common work tools and equipment;
a layer of elastomeric material adhesively affixed to said “V”-shaped cutout; and
a means of attachment of said toolshelf to a rung of an extension ladder, said means comprising two “U” bolts, each inserted into two compatible through-holes proximate and parallel to each side of said toolshelf with the legs of said “U” bolts of sufficient length to extend past the bottom surface of the rung of said ladder, thereby allowing the affixation, to each “U”-bolt, (a) a bracket accommodative of both said legs and (b) a suitable wing nut from below said bracket onto each leg of said “U”-bolts.

5. A toolshelf as in claim 1, wherein said cutout is fashioned in a contoured shape selected from the group of contoured shapes comprising circular, curvilinear, elliptical, orthogonal, and angular contoured shapes.

6. A method for enhancing safety and efficiency of work performed while using an extension ladder, comprising the steps of:
a) constructing an essentially planar, rectangular device having a top surface, a bottom surface, a front edge, a back edge, and two side edges, further having a cutout excised from said front edge of said device;
b) constructing through both top and bottom surfaces of said device, a plurality of openings, apertures, and mechanisms suitable for accommodating tools and equipment, including a circular indentation upon the top surface of said device, said indentation capable of accommodating and supporting a one-gallon can of paint; and
b) having a means of attachment of said toolshelf to a step or rung of an extension ladder comprising two “U” bolts, each inserted into two compatible through-holes proximate and parallel to each side of said toolshelf with the legs of said “U” bolts of sufficient length to extend past the bottom surface of the rung of said ladder, thereby allowing the affixation, to each said “U”-bolt, (a) a bracket accommodative of both said legs and (b) a suitable threaded fastener attached from below said bracket onto each leg of said “U”-bolts.
